(19) United States
(12) Patent Application Publication
(10) Pub. No.: US 2013/0020022 A1
(43) Pub. Date: Jan. 24, 2013

(54) INDUCTIVELY HEATABLE ADHESIVE TAPE HAVING DIFFERENTIAL DETACHMENT PROPERTIES

(71) Applicants: Klaus Keite-Telgenbüscher, Hamburg (DE); Hans Karl Engeldinger, Quickborn (DE); Judith Grünauer, Hamburg (DE)

(72) Inventors: Klaus Keite-Telgenbüscher, Hamburg (DE); Hans Karl Engeldinger, Quickborn (DE); Judith Grünauer, Hamburg (DE)

(21) Appl. No.: 13/517,927

(22) PCT Filed: Dec. 7, 2010
(86) PCT No.: PCT/EP2010/069041

§ 371 Date: Aug. 28, 2012

(30) Foreign Application Priority Data
Dec. 21, 2009 (DE) 10 2009 055 091.7

(51) Int. Cl. B32B 37/06; C09J 7/02; B32B 37/12

(52) U.S. Cl. 156/272.2; 428/212

(57) ABSTRACT

A heat-activatedly bondable sheetlike element having at least one electrically conductive sheetlike structure and at least two layers of different heat-activable adhesives. A first heat-activatable adhesive layer is located substantially on a first side of the electrically conductive sheetlike structure and the second heat-activatable adhesive layer is located substantially on a second side of the electrically conductive sheetlike structure. Activation temperatures for achieving the adhesive properties of the heat-activatable adhesive layers differ from one another less than the melting temperatures of the two heat-activatable adhesive layers.

This is a 371 of PCT/EP2010/069041 filed 7 Dec. 2010 (international filing date), and claims the priority of German Application No. 10 2009 05 091.7, filed on 21 Dec. 2009.

The invention relates to a method for adhesively bonding two substrates, more particularly two plastics substrates, to one another by means of heat-activatable adhesives, and also to a method for reparting the resultant adhered assembly of the substrates with one another.

### BACKGROUND

Heat-activatedly bondable sheetlike elements (heat-activatable sheetlike elements) are used in order to obtain high-strength connections between adherends. Especially suitable are sheetlike elements of this kind for achieving, in the case of a relatively thin bondline, strengths comparable with or higher than those possible with sheetlike, elements which contain exclusively pressure-sensitive adhesive systems. Such high-strength bonds are important particularly in light of the ongoing miniaturization of electronic devices, in the consumer electronics, entertainment electronics or communications electronics segment, for instance, as for example for cell phones, PDAs, laptops and other computers, digital cameras, and display devices such as displays and digital readers, for instance.

The requirements in terms of processability and stability of adhesive bonds are increasing significantly in portable consumer electronics articles. One reason for this is that the dimensions of such articles are becoming ever smaller, and so the area that can be utilized for an adhesive bond is also reduced. Another reason is that an adhesive bond in such devices must be particularly stable, since portable articles are required to withstand severe mechanical loads such as impacts or drops, for instance, and, moreover, are to be used across a broad temperature range.

In products of these kinds, therefore, it is preferred to use heat-activatedly bondable sheetlike elements which have heat-activatedly bonding adhesives, i.e., adhesives which at room temperature have no inherent tack, or at best a slight inherent tack, but which, when exposed to heat, develop the bond strength needed for a bond to the respective bonding substrates (adherends, adhesion base). At room temperature, heat-activatedly bonding adhesives of these kinds are frequently in solid form, but in the course of bonding, as a result of temperature exposure, are converted either reversibly or irreversibly into a state of high bond strength. Reversibly heat-activatedly bonding adhesives are, for example, adhesives based on thermoplastic polymers, whereas irreversibly heat-activatedly bonding adhesives are, for instance, reactive adhesives, in which thermal activation triggers chemical reactions such as crosslinking reactions, for example, thereby making these adhesives particularly suitable for permanent high-strength bonds.

In order to adapt heat-activatable adhesive tapes to two adherends made from different materials, such as from metal and plastic, for example, it is known in the prior art to use a multilayer adhesive tape comprising different heat-activatable adhesives on each side (see, for example, specification DE 10 2006 055 093 A1). Multilayer heat-activatable adhesive tapes of this kind are also used in areas where pressure-sensitive adhesion properties are to be incorporated into heat-activatable adhesive tapes in order, for instance, to hold the adherends in position. In that case at least one layer is designed at least partly as a pressure-sensitive adhesive, which in specific cases can also be converted by a chemical reaction—generally heat-activated—into a non-pressure-sensitively adhesive state (cf., e.g., EP 1 078 965 A1 and U.S. Pat. No. 4,120,712 A).

Also known is the production from adhesive tapes of diecuts adapted to the geometry of the bondline. In order to improve the diecutting qualities of heat-activatable films, internal polymeric films are proposed which are provided on each side with a heat-activatable adhesive, it also being possible for each of these adhesives to be different.

A feature common to all heat-activatedly bonding adhesive systems is that for bonding they must be heated. Particularly in the case of bonds where the adhesive systems are hidden from the outside over their full area by the bonding substrates, it is particularly important for the heat necessary for melting or for activating the adhesive to be transported toward the bonding area quickly. If one of the bonding substrates here is a good thermal conductor, then it is possible to heat that bonding substrate by means of an external heat source, as for example through a direct heat transfer medium, an infrared heater or the like.

In the case of such direct heating or contact heating, however, the short heating time that is needed for rapid, homogeneous heating of the known adhesive can nevertheless be realized only for a large temperature gradient between the heat source and the bonding substrate. Consequently, the bonding substrate that is to be heated ought itself to be insensitive with respect to temperatures which in some cases may even be considerably higher than actually necessary for the melting or activating of the adhesive. Accordingly, the use of heat-activatable adhesive films is problematic for plastic/plastic bonds. Plastics used in particular in consumer electronics include, for example polyvinyl chloride (PVC), acrylonitrile-butadiene-styrene copolymers (ABS), polycarbonates (PC), polypropylene (PP) or blends based on these plastics.

The situation is different, then, if none of the bonding substrates is a sufficiently good thermal conductor or if the bonding substrates are sensitive toward higher temperatures, as is the case, for example, with many plastics, but also with electronic components such as semiconductor components or liquid-crystal modules, for instance. For the bonding of bonding substrates made from materials of low thermal conductivity or from heat-sensitive materials, therefore, it is appropriate to equip the heat-activatedly bondable sheetlike element itself with an intrinsic mechanism for heating, so that the heat required for bonding need not be introduced from the outside, but is instead generated directly in the interior of the sheetlike element itself. In the prior art there are various mechanisms known that allow such internal heating to be realized, in the form, for instance, of heating by means of an electrical resistance heater, through magnetic induction or by interaction with microwave radiation.

Heating in an alternating magnetic field is achieved on the one hand through induced eddy currents in electrically conductive receptors and on the other hand to give a model-based explanation—through hysteresis losses by the surrounding elementary magnets in the alternating field. For eddy currents to develop, however, the conductive domains are required to have a certain minimum size. The lower the frequency of the alternating field, the greater this minimum size is. Depending on the receptor material, both effects occur in unison (e.g., magnetic metals) or only one effect occurs in each case (e.g., eddy currents only in the case of aluminum; hysteresis only in the case of iron oxide particles).

In principle, a variety of heating devices for inductive heating are known; one of the parameters which can be used to distinguish them is the frequencies possessed by the alternating magnetic field generated using the heating device in question. For instance, induction heating may be accomplished using a magnetic field whose frequency is situated in the frequency range from about 100 Hz to about 200 kHz (the so-called medium frequencies; ME) or else in the frequency range from about 300 kHz to about 100 MHz (the so-called high frequencies; HF). In addition, as a special case, there are also heating devices known whose magnetic field possess a frequency from the microwave range, such as the standard microwave frequency of 2.45 GHz, for example.

Rising in line with the frequency of the alternating field used is the technical cost and complexity involved in generating the alternating field, and hence the costs of the heating device. Whereas middle-frequency systems are already currently available at a market price of around 5000 euros, the outlay for high-frequency systems is at least 25,000 cures. Also rising in line with the frequency, furthermore, are the safety requirements concerning the heating system, and so, for high-frequency systems, it is regularly necessary to add, to the higher acquisition costs, higher costs for the installation of such technology as well.

Where high frequencies are used for the adhesive bonding of components in electronic devices, it is possible, furthermore, for unwanted damage to occur to electronic components in these devices in the course of their exposure to the alternating electromagnetic field.

Example applications that may be given for induction heating include manufacturing operations from the areas of bonding, seam sealing, curing, tempering, and the like. The usual technique here is to employ those methods where the inductors surround components completely or partially and heat them uniformly over the entire extent or, when required, deliberately nonuniformly, in accordance, for example, with EP 1 056 312 A2 or with DE 20 2007 003 450 U1

DE 20 2007 003 450 U1 sets out for example, inter alia, a method for fusing a container opening with a sealing film, in which the metallic inlay of a sealing film is heated by induction and a sealing adhesive is melted by conduction of heat. The containers are closed with a screw-on or snap-in lid, which comprises a metal foil and an adjacent polymeric sealing film. Using the induction coil, eddy currents are generated in the metal foil, and heat the metal foil. As a result of the contact between metal foil and sealing film, the sealing film is also heated and is thereby fused with the container opening. Induction coils in tunnel form have the advantage over flat coils that they can be used as well to seal containers having a large distance between the metal foil and the top edge of the lid, since the coil acts on the metal foil from the side.

A disadvantage of this method is that a substantially greater part of the component volume than the pure adhesive volume and the metal foil is passed through the electromagnetic field and hence, in the case of an electronic component, instances of damage are not ruled out, since heating may occur at unwanted locations. A further disadvantage is that the entire lid film is heated, whereas only the edge region in contact with the container would be sufficient for bonding. Hence there is a large ratio of heated area to bonding area, which for typical beverage bottles having an opening diameter of 25 mm and a bonding width of 2 mm is approximately 6.5. For larger container diameters, the ratio goes up in the case of the usual constant bonding width.

In recent years, for the inductive heating particularly in the bonding of plastic on plastic, inductively heatable heat-activatable adhesive films (HAFs) have moved back beneath the spotlight. The reason for this is to be found in the nanoparticulate systems that are now available, such as MagSilica™ (Evonik AG), for example, which can be incorporated into the material of the body to be heated and which thus allow heating of the body throughout its volume, without any attendant significant detriment to its mechanical stability.

Because of the small size of these nanoscopic systems, however, it is not possible to bring about efficient heating of such products in alternating magnetic fields with frequencies from the medium frequency range. For the innovative systems, instead, frequencies from the high frequency range are required. It is at these frequencies in particular, however, that the problem of damage to electronic components in an alternating magnetic field is manifested to a particularly severe extent. Generating alternating magnetic fields with frequencies in the high frequency range, moreover, requires increased cost and complexity of apparatus, and is therefore unfavorable economically. Furthermore, the use of nanoparticulate fillers is a problem from the standpoint of the environment as well, since these fillers are not easily separated from the surrounding materials on subsequent recycling. It is difficult, furthermore, to use these particles in very thin films, since the strong tendency of nanoparticulate systems to form agglomerates means that the films produced therewith are usually very inhomogeneous.

Furthermore, and in order to avoid the above problems, it is possible for heat-activatable films (HAFs) which are intended to be inductively heatable to be filled with sheetlike metallic or metalized structures. This is very efficient in the context of the use of full-area metal foils, even in the medium frequency range; high heating rates can be achieved, and so induction times of between 0.05 and 10 s can be realized. Also possible in this context is the use of very thin conductive films of between 0.25 μm and 75 μm.

Also known is the use of perforated metal foils, wire meshes, expanded metal, metal webs or fibers, through which the matrix material of the HAF is able to penetrate, thereby improving the cohesion of the assembly. The efficiency of heating, however, goes down as a result.

For adhesive bonds within mobile electronic devices, the product Duolplocoll ROD from Lohmann is known, this product being equipped with inductively heatable nanoparticles. This product can be heated in a technically utilizable way exclusively in the high frequency range. The disadvantages described above with the use of particles and high-frequency alternating fields apply to this product as well. Also shown for this product is the possibility of parting adhesive bonds, produced therewith, by means of further inductive heating. A disadvantage of particle-filled adhesive tapes of this kind is that in the case of high heating levels, the cohesion subsides and therefore, following separation of the components, residues of adhesive tape are present on both adherends, which are each contaminated with particles. For recycling of the material this is unfavorable.

The separation of bonded components by means of induction heating is known in the prior art. In many cases, particle-based adhesive systems are likewise used, with the disadvantages described above. For sheetlike susceptible materials, this is described in EP 1 453 360 A2.

Where sheetlike structures are used to generate heat in an alternating magnetic field, the problem arises that in the case of a parting of the bond by means of thermal effects (e.g., melting or chemical decomposition), it is not possible to predict with reliability which of the adherends will have the internal heat-generating sheetlike structure remaining attached to it. Here as well, therefore, difficulties as a result of contamination arise in the context of materials recycling.

### SUMMARY

It was an object of the present invention to provide a material and method with which adhesive bonds, more particularly plastic-to-plastic bonds, can be produced and separated again in a controlled way, while avoiding the disadvantages of the prior art.

### BRIEF DESCRIPTION OF THE DRAWING

FIG. 1 illustrates a system in an embodiment of the present disclosure.

### DETAILED DESCRIPTION

The object is achieved by means of a method for adhesively bonding (to form an adhesively bonded assembly) and reporting (so that the adhesively bonded assembly is separated again) two substrate surfaces, where a heat-activatedly bondable sheetlike element is used for the bonding, the heat-activatedly bondable sheetlike element comprises at least one electrically conductive sheetlike structure and also at least two layers of different heat-activatable adhesives, where the first heat-activatable adhesive layer is located substantially on one side of the electrically conductive sheetlike structure and the second heat-activatable adhesive is located substantially on the other side of the electrically conductive sheetlike structure, characterized in that
the bonding is brought about by subjecting the heat-activatedly bondable sheetlike element to a first temperature (T₁) at which there is simultaneous heat activation of the two heat-activatable adhesives,
the reporting is brought about by the bond site (that is, in particular, the heat-activatedly bonded sheetlike element) being subjected to a second temperature (T₂) at which under mandated conditions only one of the heat-activatable layers (referred to below—merely for linguistic differentiation—as “first heat-activatable adhesive”) of the heat-activatable sheetlike element loses its adhesive effect in the adhesively bonded assembly to an extent such that the adhesively bonded assembly is separated.

For the purposes of this specification, reference is made uniformly to heat-activatable adhesives and to a heat-activatedly bondable sheetlike element even in those cases where these components are present in the bonded state or after the reporting of the adhesively bonded assembly, irrespective of whether the capacity for heat-activatable bonding exists or not at that point in time. This takes account of the fact that the suitability for heat-activatable bonding existed prior to bonding, and that the respective object (where appropriate in modified, more particularly adhesively bonded, form) continues per se to exist while this expression is used.

Where it is relevant to what to extent the suitability exists or does not exist the specific state, this is made clear at the corresponding passages of text.

Consequently, for example, the designation “heat-activatedly bondable sheetlike element” also encompasses, in the corresponding cases, “heat-activatedly bonded sheetlike elements”, unless otherwise described.

Prior to the use of the sheetlike element, it is in every case a “heat-activatedly bondable sheetlike element” and the heat-activatable adhesives are adhesives of a kind which are able to develop the capacity for adhesive bonding in the sense of the application by attainment of an activation temperature above the room temperature.

The designation “the heat-activatable adhesive is located substantially on one side of the sheetlike structure” means that the adhesive on the respective side of the sheetlike element brings about bonding completely or largely, but may also, in the specific adhesive-tape construction, extend onto the other side of the electrically conductive sheetlike structure, as a result, for example, of overlapping at the sheetlike-structure edges, by merging with the opposite heat-activatable adhesive, in the case of interrupted electrically conductive sheetlike structures, for example, such as meshes, perforated plates and the like, or in another way, in any case to an extent such that the realization of the inventive concept is not affected as a result. “Substantially”, then, takes account of the fact that the respective heat-activatable adhesive may be located entirely on the respective side of the electrically conductive sheetlike structure, but need not be, provided it remains ensured that the bonding of the heat-activatedly bondable sheetlike element on the respective substrate remains critically ensured critically by the respective heat-activatable adhesive.

Sheetlike elements for the purposes of this specification include more particularly all customary and suitable structures having a substantially sheetlike extent. Such structures enable substantially two-dimensional bonding and may take different forms, being more particularly flexible, in the form of an adhesive film, adhesive tape, adhesive label or shaped diecut. The sheetlike element can be designed as a cut-to-size sheetlike element, whose shape is adapted to the shape of the bonding area, in order to reduce the risk of the bonding substrate being damaged thermally in the course of the inductive heating.

Sheetlike elements for the purposes of this specification each have two side faces, a front face and a back face. The terms “front face” and “back face” here refer to the two surfaces of the sheetlike element parallel to its principal extent (areal extent, principal plane of extent) and serve merely to distinguish these two faces, disposed on opposite sides of the sheetlike element, without the choice of the terms determining the absolute three-dimensional arrangement of the two faces; accordingly, the front face may also constitute that side face of the sheetlike element that lies at the back three-dimensionally, namely when, accordingly, the back face forms the side face thereof that lies at the front three-dimensionally.

This heat-activatedly bondable sheetlike element is intended to bond two bonding substrates to one another. For this purpose, on both side faces, the sheetlike element has a heat-activatedly bondable adhesive. Heat-activatedly bondable adhesives are all adhesives which are bonded hot at elevated temperatures and, after cooling, afford a mechanically robust connection. The adhesive is present typically in the form of an adhesive layer.

A layer is more particularly a sheetlike arrangement of a system of unitary functionality whose dimensions in one spatial direction (thickness or height) are significantly smaller than in the other two spatial directions (length and width), which define the principal extent. A layer of this kind may be compact or else perforated in form, and may consist of a single material or of different materials, particularly when these materials contribute to the unitary functionality of said layer. A layer may have different thicknesses or else a thickness which is constant over its entire areal extent. Furthermore, of course, a layer may also have more than one single functionality.

The term “heat-activatable adhesive” (also referred to in the literature as “thermally activatable adhesive”) identifies adhesives which are activated by a supply of thermal energy and are applied in this state for the utility. Adhesive bonding is produced by cooling, with a distinction being made between two systems: thermoplastic heat-activatable systems (hotmelt adhesives) set physically on cooling (generally reversibly), whereas heat-activatable elastomer/reactive component systems (heat-sealing adhesives) set chemically (generally irreversibly).

The term “heat-activatable adhesive” is not contradicted by the possibility of the adhesive in question also already having a certain inherent tack (pressure-sensitive adhesiveness, self-adhesiveness) at room temperature or at other temperatures below the activation temperature (possibly being “pressure-sensitively adhesive”). This inherent tack below the activation temperature is not, however, necessary, and so heat-activatable adhesives may also be nontacky at temperatures below the activation temperature, more particularly at room temperature.

Different heat-activatable adhesives in the sense of this specification are understood more particularly to be those heat-activatable adhesives whose behavior is such that at a temperature T_{DK}¹≦T₂—starting from the bonded state—one of the heat-activatable adhesives (the first heat-activatable adhesive) loses its adhesive effect in the adhesively bonded assembly to an extent such that the adhesively bonded assembly is separated in relation to the bonding by means of that heat-activatable adhesive, while the bonding produced by means of the other heat-activatable adhesive (identified hereinafter as “second heat-activatable adhesive”) is retained at the temperature T₂.

For the separation of the adhesively bonded assembly (in other words for the reparting the bonding of the two substrates with one another) at the temperature T₂, it may be useful to mandate further method conditions which support the parting process; for example, to make use additionally of forces with a more or less strong parting effect (tensile forces, compressive forces or the like). For the second heat-activatable adhesive it is then the case that at the temperature T₂ and under the conditions prevailing when the adhesively bonded assembly is reparted, more particularly under the influence of the forces described, it does not part the bond with the substrate to which it is bonded.

The second heat-activatable adhesive may advantageously be selected such that it for its part parts the bond with the substrate to which it is bonded at a third temperature T₃, which is above the temperature T₂.

The separation of the respective heat-activatable adhesive from the substrate to which it is bonded may take place, for example, by the respective adhesive losing, or at least suffering a severe detraction from, its bond strengths at this temperature (T₂ or T₃), by melting, softening and/or undergoing decomposition. Other mechanisms of the separating process are possible and are embraced by the basic concept of the invention.

In one preferred embodiment of the method of the invention, the temperature T₁ within the heat-activatedly bondable sheetlike element is generated by heating the electrically conductive sheetlike structure within the heat-activatedly bondable sheetlike element inductively, more particularly in a magnetic field, and transmitting the heat to the adhesives.

In another preferred embodiment, the temperature T₂ as well, preferably also the temperature T₃ which is possibly to be achieved, is brought about by inductive heating of the electrically conductive sheetlike structure.

In the method of the invention it is advantageous to use heat-activatedly bondable sheetlike elements of the kind set out in more detail below and of the kind which themselves are subject matter of the invention.

Subject matter of the invention used is, furthermore, a heat-activatedly bondable sheetlike element; the heat-activatedly bondable sheetlike element comprises at least one electrically conductive sheetlike structure and also at least two layers of different heat-activatable adhesives, where the first heat-activatable adhesive layer is located substantially on one side of the electrically conductive sheetlike structure and the second heat-activatable adhesive is located substantially on the other side of the electrically conductive sheetlike structure, the heat-activatable adhesives being selected such that they bring about bonding at a common temperature T₁, and that at a temperature T_{DK}¹ one of the heat-activatable adhesives (the first heat-activatable adhesive) loses its adhesive effect, but the other (the second heat-activatable adhesive) does not as yet.

The phrase “substantially” has the same meaning as already defined above. The temperatures at which a particular heat-activatable adhesive loses its adhesive effect in the adhesively bonded assembly is also referred to in the context of this specification as “loss-of-adhesion temperature”.

Overall, the heat-activatedly bondable sheetlike element may have any desired suitable configuration. Accordingly, in addition to the layers described above, the sheetlike element may comprise further layers, examples being permanent carriers or temporary carriers.

In one advantageous embodiment of the heat-activatable sheetlike element of the invention, the activation energies of the first heat-activatable adhesive (T_{Act}¹) and of the second adhesive (T_{Act}²) are the same or differ so little from one another that they are both situated in a temperature range in which on attainment, more particularly after exceedance, of the higher of the two activation energies, both heat-activatable adhesives develop or have already developed their adhesiveness, but without the adhesive having the lower activation energy having already suffered a loss in its adhesiveness again (for instance, by becoming too runny, undergoing decomposition or being otherwise no longer capable of achieving the required adhesive effect (that, therefore, the loss-of-adhesion temperature T_{DK} of one or both adhesives would have already been reached).

The first heat-activatable adhesive with the lower loss-of-adhesion temperature T_{DK}¹ may be that having the lower or else that having the higher activation temperature, where T_{Act}¹ and T_{Act}² are different from one another. The same thing applies in respect of the second heat-activatable adhesive with the higher loss-of-adhesion temperature T_{DK}² or without a loss-of-adhesion temperature.

In the method of the invention, the temperature T₁ is selected more particularly such that it corresponds to the higher of the two activation energies or else lies above—more particularly slightly above—that energy, meaning that both pressure-sensitive adhesives develop their adhesiveness without exceedance of a temperature at which one—or both—of the adhesives would suffer a reduction in its adhesiveness again.

The temperatures at which the heat-activatable adhesives suffer a reduction in their adhesiveness (they are no longer capable of maintaining the adhesively bonded assembly; loss-of-adhesion temperatures T_{DK}¹ for the first heat-activatable adhesive and T_{DK}² for the second heat-activatable adhesive) differ preferably so significantly that in technical terms it is possible to realize a temperature T₂ (or a temperature range T₂) such that the bonding of the first substrate with the first heat-activatable adhesive having the lower loss-of-adhesion temperature T_{DK}¹ is parted, while the bond of the second substrate with the second heat-activatable adhesive having the higher loss-of-adhesion temperature T_{DK}² (or without an existing loss-of-adhesion temperature) is (still) retained.

The temperatures T_{Act}¹, T_{Act}², T_{DR}¹ and/or T_{DK}² may be sharply defined temperatures; however, since pressure-sensitive adhesives are polymers, where phase transitions and/or other physical, chemical and/or physicochemical processes take place within temperature ranges, such temperature ranges ought to be included.

The stated temperature T then designates more particularly the temperature within the respective temperature range at which the corresponding process (heat-activation, melting, softening, decomposition, etc.) has substantially taken place, giving rise to the described success in the method (i.e., the bonding and/or reparting).

The method temperature T₁ denotes a temperature equal to or above the activation temperatures T_{Act}¹ and T_{Act}² of the heat-activatable adhesives.

The method temperature T₁ identifies a temperature equal to or above the loss-of-adhesion temperature T_{DK}¹ of the first heat-activatable adhesive; where the second heat-activatable adhesive also possesses a loss-of-adhesion temperature, T_{DK}², T₂ is situated below T_{DK}².

The method temperature T₃ identifies a temperature equal to or above the loss-of-adhesion temperature T_{DK}^{2*}.

As has already beer set out, loss-of-adhesion temperatures contemplated for the heat-activatable adhesives, independently of the other heat-activatable adhesive in each case, include more particularly their respective melting temperature, softening temperature, decomposition temperature or the like; it is of course also possible for the loss of adhesion of both heat-activatable adhesives to derive from the same effect.

One advantageous embodiment of the adhesive tapes of the invention relates to a heat-activatedly bondable sheetlike element comprising at least one electrically conductive sheetlike structure and also a layer of a heat-activatable adhesives on both sides of the electrically conductive sheetlike structure, the two heat-activatable adhesives being different from one another, and the activation temperatures for achieving the adhesive properties of the heat-activatable adhesives differing less from one another than their loss-of-adhesion temperatures, more particularly than their melting temperatures and/or than their decomposition temperatures.

The heat-activatedly bondable sheetlike elements of the invention and the method of the invention are suitable in particular for adhesive bonds between at least two identical or different electrically nonconducting materials (substrates in the sense of the expression used above), more particularly those having thermal expansion coefficients of in each case less than 5 W/mK, more preferably in electronic devices.

In accordance with the invention, the bonding may be carried out in a temperature range which is the same for both, with both adhesives obtaining the full bonding strength (without one of the materials not achieving its complete bonding strength, e.g., as a result of incomplete curing or melting). Advantageously, none of the materials involved (substrates, adhesives) is damaged by excessive temperature.

Through the choice of the temperature T₂ in connection with the parting of the bond, more particularly a lower temperature, it is possible, moreover, to predetermine reliably that adherend to which the electrically conductive sheetlike structure remains adhering. This is advantageous for the recycling procedure of the devices, more particularly electronic devices, especially for the clean sorting of materials.

Success has been achieved, surprisingly, in spite of two different adhesive systems and additional boundary layers present in the bondable sheetlike element, in achieving bonding strengths on the electrically conductive sheetlike structure that are otherwise achieved only with single systems, such as particle-filled adhesives, for example, which are present homogeneously in the bondline.

In one especially advantageous version, the heat-activatedly bondable sheetlike element has a thickness of less than 70 μm, more particularly of less than 50 μm, very particularly of less than 30 μm, since by this means it is possible to produce particularly thin adhesive bonds.

Embraced by the invention is a method for producing an adhesive bond by providing a heat-activatedly bondable sheetlike element of the invention, more particularly in the geometry of the adhesive bond that is to be produced (e.g., as a shape or diecut),
this sheetlike element is applied into the bondline,
the bondline is subjected to pressure, the pressure being applied by a pressing device, of which at least one pressing tool comprises a device for generating an alternating magnetic field,
and the sheetlike element is heated by means of induction to a temperature at which both adhesive systems are activated.

Further embraced by the invention is a method for parting an adhesive bond, more particularly subsequent to the method set out above for producing an adhesive bond, in which an adhesive bond produced with a heat-activatedly bondable sheetlike element adhesive tape of the invention is heated by means of induction, characterized in that
the lower of the temperatures required for the two heat-activatable adhesives for lowering the adhesion and/or the cohesion is not substantially exceeded.

The sheetlike element of the invention can be heated using an induction heating means (inductor) which is customary for inductive heating. Induction heating means (inductors) contemplated include all customary and suitable arrangements, in other words, for instance, coils, conductor loops or conductors through which an alternating electrical current passes, and which generate an alternating magnetic field of appropriate strength as a result of the current passing through them. Accordingly, the magnetic field strength necessary for heating may be provided by a coil arrangement with an appropriate number of turns and length of coil, through which a corresponding current is passing, in the form of a point inductor, for example. This inductor may be designed without a ferromagnetic core or else may have a core, made of iron or pressed ferrite powder, for example. The preliminary assembly may be exposed directly to the magnetic field thus generated. Alternatively, of course, it is also possible to arrange the above coil arrangement as a primary winding on the primary side of a magnetic field transformer, on whose secondary side a secondary winding provides a correspondingly higher current. As a result, the actual excitation coil, arranged in the immediate vicinity of the preliminary assembly, can have a lower number of turns, as a result of the higher current, without the field strength of the alternating magnetic field being reduced as a result.

Where the preliminary assembly is subjected to a pressing pressure during the inductive heating, this additionally necessitates a pressing device. Pressing devices used may be all devices suitable for exerting a pressing pressure, examples being discontinuously operating pressing machines such as, for instance, a pneumatic press or hydraulic press, an eccentric press, a crank press, a toggle press, a spindle press or the like, or else continuously operating pressing machines such as, for instance, a pressing roil. The device may be provided as a separate unit or else may be present in conjunction with the inductor. It is preferred, for instance, to employ a device which as a first pressing tool comprises at least one press-ram element which also has an induction heating means. As a result, the induction field can be brought very close to the bond site that is to be formed, and thus can also be limited three-dimensionally to the area of this bond site.

For the inductive heating it is possible advantageously to select the following parameters:
a frequency of between 1 and 200 kHz, since at low frequencies higher depths of penetration can be achieved and a better control of the heating rate is possible. Particularly preferred for use in the method are frequencies of 1 to 40 kHz, more particularly of 1 to 15 kHz, since in this Case the effective depth of penetration of the magnetic field is further increased.
Implementation of heating within a time of less than 20 seconds to a temperature of more than 70° C.

The method is used with particular advantage when the heated area is smaller than 5 cm². With the method it is possible, surprisingly, to prevent uncontrolled melting of the bonding substrates, which in that case are very delicate.

With particular advantage the method is additionally used when the bondline is formed as a noncontinuous area. By such are meant, on the one hand, recesses and/or perforated areas, and on the other hand, also, areas composed substantially of linear elements, as for example a comb structure, where individual elements have an aspect ratio (length to width) of more than 2.

In one particularly advantageous version of the method, heating is accompanied by the exertion of a pressing pressure which amounts to more than 0.2 MPa. In this way it is possible to prevent formation of bubbles as a result of desorbing gases or gases which form in a chemical reaction, and in particular as a result of steam. Preferred for high crosslinking temperatures is a pressure of more than 0.5 MPa.

In a further, particularly advantageous version of the method, in contrast, the pressure is less than 0.2 MPa, since in this way it is possible to prevent the oozing of adhesive, more particularly of thermoplastic adhesive, from the bondline.

In one particularly advantageous version, the heating rate is not more than 200° C./s, more particularly not more than 100° C./s, since at higher heating rates there is a high risk of physical damage to the heat-activatable adhesive or of uncontrolled melting and/or thermal damage of the substrate. Limiting the heating rate in this way may be achieved, for example, by the use of metals of lower electrical conductivity (e.g., aluminum instead of copper, or steel instead of aluminum). Another technical means of limiting the heating rate is to use perforated metallic sheetlike structures, e.g., expanded metal mesh).

In a further advantageous version of the method, the pressure is maintained after the heating of the sheetlike element in order to allow strengthening of the bondline by physical or chemical mechanisms. It is also advantageous to carry out this subsequent pressing time in a second pressing device, which need no longer include an inductor, in order thereby to reduce the cycle time.

In a further advantageous version of the method, in at least part of this subsequent pressing time, there is also further induction heating of the adhesive tape, since in this way it is possible advantageously to maintain the temperature in the bondline. This subsequent heating is advantageously carried out at a lower heating rate than the original heating.

By virtue of the fact that the adhesive tape is provided preferably in the geometry of the bond area, it is ensured that the heating takes place only in the areas needed for bonding. The risk of thermal damage is therefore reduced. The geometry can be produced by any of the techniques familiar to the skilled person, such as, for example, cutting, punching, laser cutting, water-jet cutting.

A further advantage of the method is that the inductor is integrated in at least one of the pressing tools, since in this way the induction field can be brought very close to the bond site and can also be confined three-dimensionally to said bond site.

### Heat-Activatable Adhesives

As heat-activatable adhesives it is possible in particular to use hotmelt adhesives, reactive adhesives or reactive hotmelt adhesives.

The first heat-activatable adhesive preferably possesses a loss-of-adhesion temperature (T_{OK}¹) which is between 10 and 20° C., preferably between 20 and 50° C. more preferably at least 50° C. above the activation temperature (T_{Act}^{2*}) of the second heat-activatable adhesive. This ensures that within one heating cycle it is possible to activate both adhesives reliably without already activating the detachment mechanism (the decomposition) for the first adhesive. With a difference of 10-20″C, the temperature needed to separate the bond is relatively low, hence allowing heating time and/or energy to be saved.

In the case of a difference in the aforementioned temperatures (T_{DK}¹, E_{Act}²) of more than 50° C., the method is very reliable, since larger tolerances in the temperature regime are allowed when bonding.

The range for a temperature difference of 20° C. to 50° C. is an advantageous compromise between the two variants.

In one particularly preferred version, the first heat-activatable adhesive is or comprises a reactive adhesive, or is or comprises a reactive hotmelt adhesive, and/or the second heat-activatable adhesive is or comprises a hotmelt adhesive, with the melting temperature of the hotmelt adhesive being selected very preferably to be lower than the decomposition temperature of the reactive system.

As a result of this, the adhesive bond can be parted without chemical decomposition and hence without possible hazard as a result of gases or other decomposition products formed in the process.

In a further preferred embodiment, at least one heat-activatable adhesive is admixed with fractions of at least one material which accelerate the decomposition or which preferentially decompose and so weaken the adhesive bond and lead to the parting thereof. Examples of such are known to the skilled person and set out for example in U.S. Pat. No. 5,272,216. The corresponding materials disclosed therein are explicitly included in the disclosure scope of the present specification.

As the at least one heat-activatedly bondable adhesive it is possible in principle to employ all customary heat-activatedly bondable adhesive systems. Heat-activatedly bondable adhesives can be divided in principle into two categories: thermoplastic heat-activatedly bondable adhesives (hotmelt adhesives), and reactive heat-activatedly bondable adhesives (reactive adhesives). This subdivision also includes those adhesives which can be assigned to both categories, namely reactive thermoplastic heat-activatedly bondable adhesives (reactive hotmelt adhesives).

Thermoplastic adhesives are based on polymers which soften reversibly on heating and solidify again in the course of cooling. In contrast to these, reactive heat-activatedly bondable adhesives comprise reactive components. The latter constituents are also referred to as “reactive resins”, in which heating initiates a crosslinking process which, after the end of the crosslinking reaction, ensures a permanent stable bond even under pressure. Thermoplastic adhesives of this kind preferably also comprise elastic components, examples being synthetic nitrile rubbers. Such elastic components give the heat-activatedly bondable adhesive a particularly high dimensional stability even under pressure, on account of their high flow viscosity.

Described below, purely by way of example, are a number of typical systems of heat-activatedly bondable adhesives which have emerged as being particularly advantageous in connection with the present invention.

A thermoplastic heat-activatedly bondable adhesive, then, comprises a thermoplastic base polymer. This polymer has good flow behavior even under low applied pressure, and so the ultimate bond strength that is relevant for the durability of a permanent bond comes about within to short applied-pressure time, and, therefore, rapid bonding is possible even to a rough or otherwise critical substrate. As thermoplastic heat-activatedly bondable adhesives it is possible to use all of the thermoplastic adhesives known from the prior art.

Suitability is possessed for example by those heat-activatable adhesives of the kind described in DE 10 2006 042 816 A1, without wishing these details to impose any restriction.

Exemplary compositions are described in EP 1 475 424 A1, for instance. Hence the thermoplastic adhesive may comprise, or even consist of, for example, one or more of the following components: polyolefins, ethylene-vinyl acetate copolymers, ethylene-ethyl acrylate copolymers, polyamides, polyesters, polyurethanes or butadiene-styrene block copolymers. Employed preferably, for instance, are the thermoplastic adhesives listed in paragraph [0027] of EP 1 475 424 A1. Further thermoplastic adhesives, particularly suitable especially for specific fields of use such as the bonding of glass bond substrates, for example, are described in EP 1 95 60 63 A2. It is preferred to use thermoplastic adhesives whose melt viscosity has been raised by rheological additives, as for example through addition of fumed silicas, carbon black, carbon nanotubes and/or further polymers as blend components.

A reactive heat-activatedly bondable adhesive, in contrast, advantageously comprises an elastomeric base polymer and a modifier resin, the modifier resin comprising a tackifier resin and/or a reactive resin. Through the use of an elastomeric base polymer it is possible to obtain adhesive layers having outstanding dimensional stability. As reactive heat-activatedly bondable adhesives it is possible, in line with the specific requirements in each case, to use all of the heat-activatedly bondable adhesives that are known from the prior art.

Also included here, for example, are reactive heat-activatedly bondable films based on nitrile rubbers or derivatives thereof such as, for instance, nitrile-butadiene rubbers or mixtures (blends) of these base polymers, additionally comprising reactive resins such as phenolic resins, for instance; one such product is available commercially under the name tesa 8401, for instance. On account of its high flow viscosity, the nitrile rubber gives the heat-activatedly bondable film a pronounced dimensional stability, allowing high bond strengths to be realized on plastics surfaces after a crosslinking reaction has been carried out.

Naturally, other reactive heat-activatedly bondable adhesives can be used as well, such as, for instance, adhesives comprising a mass fraction of 50% to 95% by weight of a bondable polymer and a mass fraction of 5% to 50% by weight of an epoxy resin or a mixture of two or more epoxy resins. The bondable polymer in this case comprises advantageously 40% to 94% by weight of acrylic acid compounds and/or methacrylic acid compounds of the general formula CH₂═C(R¹)(COOR²) (R¹ here represents a radical selected from the group encompassing H and CH₃, and R² represents a radical selected from the group encompassing H and linear or branched alkyl chains having 1 to 30 carbon atoms), 5% to 30% by weight of a first copolymerizable vinyl monomer which has at least one acid group, more particularly a carboxylic acid group and/or sulfonic acid group and/or phosphonic acid group, 1% to 10% by weight of a second copolymerizable vinyl monomer which has at least one epoxide group or an acid anhydride function, and 0% to 20% by weight of a third copolymerizable vinyl monomer which has at least one functional group different from the functional group of the first copolymerizable vinyl monomer and from the functional group of the second copolymerizable vinyl monomer. An adhesive of this kind allows bonding with rapid activation, the ultimate bond strength being achieved within just a very short time, with the result, overall, that an effectively adhering connection to a nonpolar substrate is ensured.

A further reactive heat-activatedly bondable adhesive which can be used, and which affords particular advantages, comprises 40% to 98% by weight of an acrylate-containing block copolymer, 2% to 50% by weight of a resin component, and 0% to 10% by weight of a hardener component. The resin component comprises one or more resins selected from the group encompassing bond strength enhancing (tackifying) epoxy resins, novolak resins, and phenolic resins. The hardener component is used for crosslinking the resins from the resin component. On account of the strong physical crosslinking within the polymer, a formulation of this kind affords the particular advantage that adhesive layers having a greater overall thickness can be obtained, without detriment overall to the robustness of the bond. As a result, these adhesive layers are particularly suitable for compensating unevennesses in the substrate. Moreover, an adhesive of this kind features good aging resistance and exhibits a low level of outgassing, a particularly desirable feature for many bonds in the electronics segment.

As already mentioned above, however, apart from these particularly advantageous adhesives, it is also possible in principle to select and use all other heat-activatedly bondable adhesives in line with the particular profile of requirements for the adhesive bond.

Also used advantageously, furthermore, are reactive pressure-sensitive adhesives, including more particularly those suitable for structural adhesive bonding. Adhesives of this kind are disclosed for example by specifications DE 199 05 800 B4 and EP 0 881 271 B1, whose disclosure content in this respect is incorporated into the disclosure of the present specification.

In one advantageous version of the invention, both heat-activatable adhesives are selected such that after the bond has been produced, by heating of the heat-activatedly bondable sheetlike element by magnetic induction, the bond strength in a static shear test on polycarbonate is greater than 100 MPa, preferably between 100 and 300 MPa, and very preferably greater than 400 MPa.

It is advantageous, furthermore, if at least one of the two, but possibly also both, heat-activatable adhesives, is present only partially coated on the electrically conductive sheetlike structure, as for instance in the form of geometric areas (e.g., dots, triangles, diamonds or hexagons) or linear patterns (e.g. bridges, lines, lattices or waves). In this way it is possible to achieve a further differentiation in the parting force on the two sides.

In another advantageous variant of the invention, the heat-activatable adhesive layers are given different thicknesses. This has the advantage that differences in bond strength between the different kinds of adhesives can be compensated by a higher or lower layer thickness.

### Electrically Conductive Sheetlike Structures

In principle the at least one electrically conducting sheetlike structure may be of any desired suitable design—for example, as a thin layer which is perforated (in the form of a lattice, for example) or is compact over its full area. The layer thickness of the electrically conducting layer is preferably less than 50 μm, more particularly less than 20 μm or even less than 10 μm. The latter makes it possible to limit the heating rate toward the top end in a relatively simple way.

As inductively heatable material of the electrically conductive sheetlike structure, the materials selected are more particularly those materials, more particularly in layer form, of the kind known per se for this purpose from the prior art. An electrically conducting layer is considered to be any layer of at least one material which at a temperature of 23° C. has a conductivity (electrons and/or holes) of at least 1 mS/m, thus allowing an electrical current flow in said material. Such materials are, in particular, metals, semimetals, and also other metallic materials, and possibly also semiconductors, in which the electrical resistance is low. Accordingly, the electrical resistance of the electrically conducting layer is on the one hand high enough to allow healing of the layer when an electrical current is passing through the layer, but on the other hand also low enough for a current flow to be actually established through the layer. Also considered to be electrically conducting layers, as a special case, are layers of materials which have a low magnetic resistance (and hence a high magnetic conductivity or magnetic permeability), examples being ferrites, although these frequently have a relatively high electrical resistance given alternating currents of low frequencies, and so heating here is frequently achieved only with alternating magnetic field frequencies that tend to be relatively high.

It is preferred, for example, to use electrically conductive sheetlike materials (sheetlike structures), since they can be heated at low frequencies, resulting in a higher depth of penetration of the magnetic field and also in lower equipment costs. These electrically conductive sheetlike structures preferably have a thickness of less than 50 μm, more particularly less than 20 μm and very preferably less than 10 μm, since the adhesive tapes become more flexible as the thickness of the electrically conducting sheetlike structure decreases. By this means it is possible to provide particularly thin adhesive tapes; moreover, the amount of electrically conductive material remaining on one adherend can be reduced.

In one advantageous embodiment, the electrically conducting layer of the heat-activatedly bondable sheetlike element has a layer thickness of less than 20 μm, more particularly of less than 10 μm, in order for its heating rate to be limited in a particularly simple way. Furthermore, the sheetlike element may have a further heat-activatedly bondable adhesive layer. A sheetlike element of this kind is particularly suitable, as a double-sidedly bondable sheetlike element, for joining two bond substrates to one another.

At the same time, additionally, the electrically conducting layer is preferably also magnetic, more particularly ferromagnetic or paramagnetic. Although it was expected of such materials that, in addition to the induction of eddy currents, there would also be heating in the materials as a result of hysteresis losses, and that the heat-up rate overall would be greater, it was observed, in contrast, that even magnetic materials such as nickel or magnetic steels, which are good conductors of electrical current, in fact consistently have lower heat-up rates than materials which, while being very good conductors of electrical current, are themselves not magnetic, examples being copper or aluminum. Through use of magnetic materials which conduct electrical current, therefore, the heat-up can be controlled more easily and the incidence of heat-up effects outside of the bondline can be reduced.

It is favorable, furthermore, if the electrically conducting layer has an electrical conductivity of more than 20 MS/n (which is achievable, for example, through use of aluminum), more particularly of more than 40 MS/n (which is achievable, for example, through use of copper or silver), in each case determined for 300 K. In this way it is possible to realize the sufficiently high temperatures in the bondline that are needed in order to produce high strengths of the adhesive bond, and also to realize homogenous through-heating even in very thin sheetlike elements. Surprisingly it has been observed that the heating as a consequence of induced eddy currents goes up with increasing conductivity and not, as expected, with increasing electrical resistance.

### EXPERIMENTAL SECTION

### Example

As heat-activable adhesive, use was made of heat-activable adhesive films based on different chemistries and in different thicknesses (see table). For this purpose it was possible in part to employ commercially available heat-activatable films (tesa SE).

In order to achieve thicknesses of adhesive which are thinner than those available commercially, relatively thick products were dissolved in 2-butanone, and adhesive, layers in the required thickness were prepared from the solution, by coating out and drying.

The electrically conductive sheetlike structure used for induction heating was an aluminum foil having a thickness of 36 μm. The metal foil was laminated on both sides with the layers of adhesive at a temperature of around 90° C. At this point, the chemical crosslinking reaction is still not initiated, and instead only adhesion is brought about.

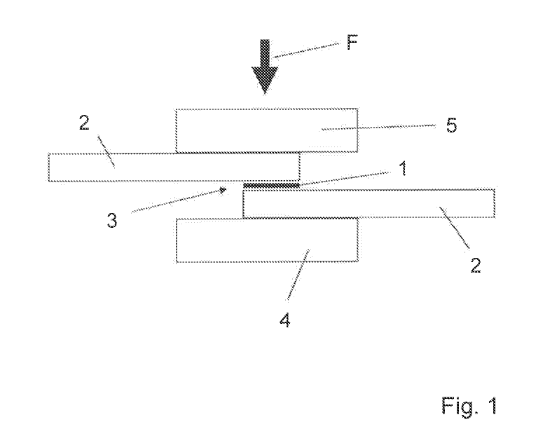

The bond substrates used for the inventive adhesive tape 1 were two polycarbonate sheets 2 having a width of 20 mm, a length of 100 mm and a thickness of 3 mm, which overlapped in the bondline 3 by 10 mm (cf. FIG. 1). The bonding area here, accordingly, comprised a rectangle with an edge length of 10×20 mm. In order to investigate the differential separation of the adhesive tape, the adherends were selected from the same material. FIG. 1 also shows, schematically, the lower press-ram element 4, the upper press-ram element 5, and the force F.

The bonding method was carried out using a modified induction system of type EW5F from IFF GmbH, Ismaning. Serving as the inductor for local provision of the alternating magnetic field here is an induction field transformer composed of just one water-cooled current-bearing conductor, which is used as a secondary coil circuit in a transformer-field transformer and which interacts in a coaxial transformer with the transformer field generated on the primary coil side. The induction field transformer was embedded into a matrix of polyetheretherketone (PEEK) and the resultant arrangement was used as the lower press-ram element 4 of a pressing device, which also has an upper press-ram element 5. The applied pressure on the basis of the force F to which the preliminary assembly was subjected between the lower press-ram element 4 and the upper press-ram element 5, perpendicularly to the side faces of the heat-activatedly bondable sheetlike element, was 2 MPa in each case.

With the aid of the modified induction system, alternating magnetic fields with a frequency of 20 kHz, with a pulse width of 30%, were generated. The pulse width indicates the percentage fraction of the pulse duration (pulse length) of the alternating magnetic field as a proportion of the overall period duration (the sum of pulse duration and the duration of the pauses between two successive pulses) of the alternating magnetic field.

The time for which the heat-activatedly bondable sheetlike element was exposed to the pulsed alternating magnetic field (i.e, the duration of inductive heating) was set such that the temperatures indicated in each case were attained, and was situated more particularly in a range from 1 to 6 seconds.

All of the tests were carried out, furthermore, with a subsequent pressing time of 5 seconds, in which inductive afterheating took place in an alternating magnetic field of the same frequency as for the thermal activation of the adhesives, with a pulse width of 20% (corresponding to a ratio of pulse duration to pause duration of 1:4).

The measurement variable selected was the bond strength in a dynamic tensile shear test based on DIN 53283 at 23° C. with a testing speed of 1 mm/min. All of the tests were repeated 10 times.

For the parting (separation) of the adhesive bond, inductive heating took place to the temperatures indicated below, without any significant applied pressure, after which the sample rods were taken from the induction press and immediately separated by hand while hot by bending.

The following table shows the examples:

Heat-activatable adhesive films (HAF)

| | | | Used in the form of |
|---|---|---|---|
| HAF # | Basis | Thickness | commercial product: tesa ® |
| HAF1 | N/P | 30 | 8435 |
| HAF2 | N/P | 30 | 8471 |
| HAF3 | PA | 40 | 8440 |
| HAF4 | PET | 100 | 8464 |
| HAF5 | SR/EP | 35 | 8865 |
| HAF6 | N/P | 100 | 8454 |

Abbreviations:
N/P: Nitrile rubber/phenolic resin
PA: Copolyamide
PET: Copolyester
SR/EP: Synthetic rubber/epoxy resin

| | Adhe- | Adhe- | Bonding | Parting | | |
|---|---|---|---|---|---|---|
| | sive | sive | temper- | temper- | | Separa- |
| Exam- | side 1 | side 2 | ature (T₁) | ature (T₂) | Strength | tion on |
| ple | HAF # | HAF # | [° C.] | [° C.] | [MPa] | sides |
| 1 | HAF1 | HAF3 | 110 | 180 | 4 | all side 2 |
| 2 | HAF2 | HAF4 | 120 | 180 | 6 | all side 2 |
| 3 | HAF3 | HAF4 | 115 | 160 | 7 | all side 1 |
| 4 | HAF1 | HAF5 | 160 | 300 | 12 | all side 2 |
| 5 | HAF6 | HAF1 | 160 | 300 | 13 | all side 1 |
| V1 | HAF1 | HAF1 | 160 | 300 | 13 | 3 × side 1 |
| | | | | | | 7 × side 2 |
| | | | | | | in 10 tests |

The examples show that with the selected combinations it is possible to produce high-strength bonds in accordance with the prior art. Furthermore, all of the different pairings of adhesive underwent separation on the anticipated side, whereas with the comparative example it was not possible to give a reliable prediction of the side. This shows the advantages of the adhesive tapes of the invention.

We claim:

1. A method for adhesively bonding and reparting two substrate surfaces,
where a heat-activatedly bondable sheetlike element is used for the bonding the two substrate surfaces,
the heat-activatedly bondable sheetlike element comprises at least one electrically conductive sheetlike structure and at least two layers of different heat-activatable adhesives,
where a first heat-activatable adhesive layer is located substantially on a first side of the electrically conductive sheetlike structure and a second heat-activatable adhesive is located substantially on a second side of the electrically conductive sheetlike structure,
wherein
the bonding is brought about by subjecting the heat-activatedly bondable sheetlike element to a temperature T₁ at which there is simultaneous heat activation of the first and second heat-activatable adhesives,
the reparting is brought about by subjecting the bond site to a temperature T₂ at which, under mandated conditions, only one of the first and second heat-activatable layers of the heat-activatedly bondable sheetlike element loses its adhesive effect in the adhesively bonded assembly to an extent such that the adhesively bonded assembly is separated.

2. The method according to claim 1, wherein the temperature T₁ for producing the bonding is brought about by inductive heating of the electrically conductive sheetlike structure.

3. The method according to claim 1, wherein the temperature T₂ for producing the reparting of the adhesively bonded assembly is brought about by inductive heating of the electrically conductive sheetlike structure.

4. The method according to claim 1, wherein the reporting of the adhesively bonded assembly at the temperature T₂ is brought about by melting or by decomposition of the corresponding heat-activatable adhesive layer.

5. A heat-activatedly bondable sheetlike element, comprising at least one electrically conductive sheetlike structure and at least two layers of different heat-activable adhesives,
wherein a first heat-activatable adhesive layer is located substantially on a first side of the electrically conductive sheetlike structure and the second heat-activatable adhesive layer is located substantially on a second side of the electrically conductive sheetlike structure,
wherein activation temperatures for achieving the adhesive properties of the heat-activatable adhesive layers differ from one another less than the melting temperatures of the two heat-activatable adhesive layers.

6. A heat-activatedly bondable sheetlike element, comprising at least one electrically conductive sheetlike structure and at least two layers of different heat-activable adhesives,
wherein a first heat-activatable adhesive layer is located substantially on a first side of the electrically conductive sheetlike structure and a second heat-activatable adhesive layer is located substantially on a second side of the electrically conductive sheetlike structure,
wherein activation temperatures for achieving the adhesive properties of the heat-activatable adhesive layers differ from one another less than the decomposition temperatures of the two heat-activatable adhesive layers.
